(19) United States
(12) Patent Application Publication
(10) Pub. No.: US 2004/0064295 A1
(43) Pub. Date: Apr. 1, 2004

(54) Methods for modular-parametric-finite-element modeling

(76) Inventors: Jiping Zhang, Winter Springs, FL (US); Henk Van Ravenswaay, Dusseldorf (DE)

Correspondence Address: Siemens Corporation, Intellectual Property Department, 186 Wood Avenue South, Iselin, NJ, 08830, US

(21) Appl. No.: 10/255,895

(22) Filed: Sep. 26, 2002

(51) Int. Cl. G06F 17/10

(52) U.S. Cl. 703/2

(57) ABSTRACT

A modular method of modeling a product using finite-element-modeling (FEM) software is disclosed that facilitates flexibility and reusability of FEM input-text files. In an exemplary embodiment, a user conceptually divides the product into segments (22, 24, 26). The user then identifies desired variations to the segments, which form the basis for a plurality of modules (27-38). The user then creates module-input-text files for each module and stores the files in a data processing system (10) for subsequent use. When the user wishes to model a particular variation of the product, the user selects the module-input-text files corresponding to that variation, inputs them into the FEM software, and defines the connectivity between the selected modules.

### FIELD OF THE INVENTION

The present invention relates to finite-element-modeling (FEM) software, and more particularly to methods of creating modular-parametric-finite-element models for use with FEM software.

### BACKGROUND

FEM is a mathematical technique for obtaining approximate solutions to a wide variety of complex engineering problems. FEM is very useful, for example, for modeling and analyzing mechanical and thermal characteristics of engineered products. Recent advances in computer technology have led to an increased use of FEM. Examples of commercially available FEM software include ANSYS™, available from Swanson Analysis Systems, Inc., ADINA™, available from R & D, Inc., and ABAQUS™, available from Hibbitt, Karisson, & Sorenson, Inc.

Modeling a product with FEM software generally involves three steps: (1) building a model of the product, (2) performing an analysis by applying loads to the model, and (3) reviewing the results of the analysis. Steps 1-3 may be repeated many times in order to iteratively approach an optimized product design. The first step, building a model, presents a number of challenges. In the first step, a user must write one or more input text files to instruct the FEM software to generate a model. Different FEM software vendors have their own proprietary language and syntax for writing input text files and conventional input-text files can grow to be hundreds of lines long. As a result, conventional input-text files are often complex and difficult to modify.

One attempt to address the above challenges has been the use of parametrics. Parametrics enable a user to build a model in terms of variables, rather than specific values. ANSYS™ software, for example, provides parametric functionality with its ANSYS™ Parametric Design Language (APDL). Parametrics enable a user to make minor dimensional changes to a model by redefining the parameters corresponding to the changes. Parametrics can only handle minor dimensional changes. Changes in a model's geometry, even slight ones, generally require major changes in the corresponding input-text file and may require a new input-text file.

A second attempt to address the challenges discussed above is disclosed in “Modularized & Parametric Modeling Methodology for Concurrent Mechanical Design of Electronic Packaging,” Wen X. Zhou (1997). Zhou discloses a modularized and parametric modeling methodology for linear-elastic structures for electronic packaging, such as printed circuit boards. In Zhou, models are treated as continuous structures. After modularized geometric primitives (MGPs) are modeled, they are merged into a linear elastic structure having a single domain. However, Zhou does not provide for interactivity between components and therefore does not provide for multiple domains.

### SUMMARY OF THE INVENTION

With the foregoing in mind, the present invention provides a modular approach to building FEM models using FEM software that significantly increases the flexibility and reusability of FEM input-text files. The modular approach enables the creation of “off the shelf” modules that can be mixed and matched to permit a user to make geometric and other changes to a model, without having to rewrite a complex input-text file. This modular approach significantly simplifies complex modeling projects by centering on modules that result in smaller, simpler input-text files that can be easily reused, modified, and debugged. As a result, shorter design cycles, higher modeling quality, and better end products are possible.

These and other objects, features, and advantages in accordance with the present invention are provided by a method of modeling a product with finite-element-modeling (FEM) software, which comprises the steps of (a) conceptually dividing said product into a plurality of segments; (b) determining desired variations to said segments to conceptually define a plurality of modules for each of said segments; (c) creating module-input-text files corresponding to each of said plurality of modules; (d) storing said module-input-text files in a data processing system for subsequent use with said FEM software; (e) generating a model of a selected product comprising a selected module for each of said segments of said product by (i) retrieving said module-input-text files corresponding to each of said selected modules; (ii) inputting said module-input-text files into said FEM software; and (ii) defining interactivity and connectivity between said selected FEM modules and to form an assembled model of said product; and (f) performing an analysis of said model of said product using said FEM software.

A method is also provided for modeling a product using FEM software in a data processing system, which comprises the steps of (a) retrieving from said data processing system pre-prepared module-input-text files for each of a plurality of selected modules corresponding to said product to be modeled; (b) inputting said module-input-text files into said FEM software to generate models of said selected modules of said product; (c) storing said models of said selected modules in said data processing system; (d) inputting an assembly-input-text file into said FEM software, which retrieves said stored modules, defines connectivity and interactivity between said modules, and generates an assembled model of said product; and (e) performing an analysis on said model by applying loads to said model using said FEM software.

A method is also provided for modeling a product using FEM software in a data processing system, which comprises the steps of (a) retrieving from said data processing system pre-prepared module-input-text files for modules corresponding to said product to be modeled; (b) modifying parameters in said input-text files to effect desired changes in said product to be modeled; (c) inputting said module-input-text files into said FEM software to generate models of said modules; (d) storing said models in said data processing system; (e) retrieving from said data processing system a pre-prepared assembly-input file, said assembly-input file including instructions for defining multiple-domain connectivity between said modules and for retrieving said stored models; (f) inputting said assembly-input file into said FEM software, thereby retrieving said stored models and generating an assembled model of said product; and (e) performing an analysis on said assembled model by applying loads to using said FEM software.

A method is also provided for modeling a product with FEM software in a data processing system using pre-existing non-parametric FEM models, which comprises the steps of (a) retrieving said pre-existing FEM models from said data processing system; (b) modifying said pre-existing non-parametric FEM models to delete instructions not utilized by a modular-input-text file; and (c) storing said modified FEM models for subsequent use with modular-input-text files.

### BRIEF DESCRIPTION OF THE DRAWINGS

FIG. 1 illustrates an exemplary data processing system suitable for implementing methods consistent with the present invention.

FIG. 2 illustrates an example of a product to be modeled.

FIG. 3 illustrates the product of FIG. 2 divided segments and modules.

FIG. 4 is a flow diagram illustrating the preparation phase of an exemplary embodiment of the present invention.

FIG. 5 is a flow diagram illustrating the assembly phase of an exemplary embodiment of the present invention.

### DETAILED DESCRIPTION

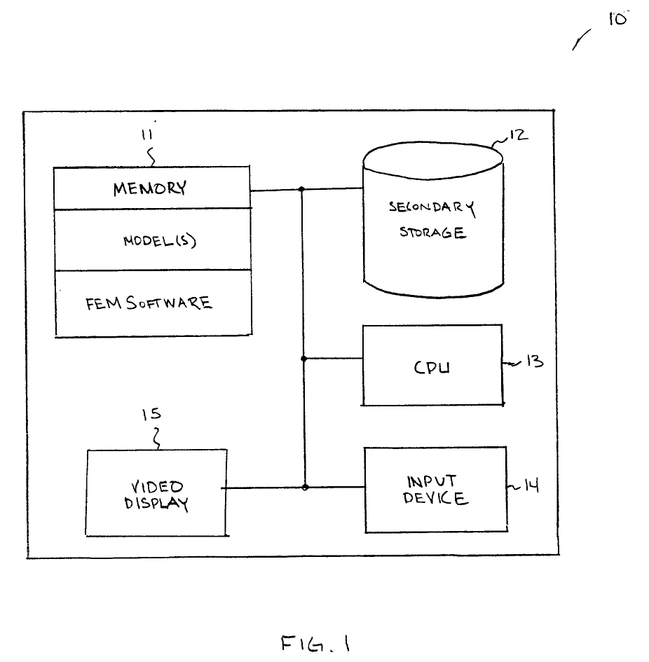

Methods consistent with the present invention may be implemented, for example, with ANSYS™, ADINA™, ABAQUS™, or any FEM software with similar characteristics and may be implemented using different computer hardware and operating systems. For exemplary purposes, a data processing system 10 suitable for use with the present invention is illustrated in FIG. 1. The data processing system 10 includes memory 11 that stores FEM software and models associated with the software. The data processing system 10 also includes a secondary storage device 12 for storing files associated with the FEM software, a central processing unit 13, an input device 14, such as a keyboard or a mouse, and a video display 15.

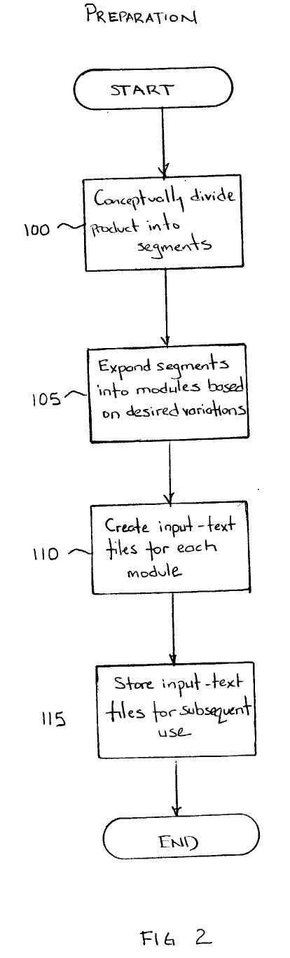

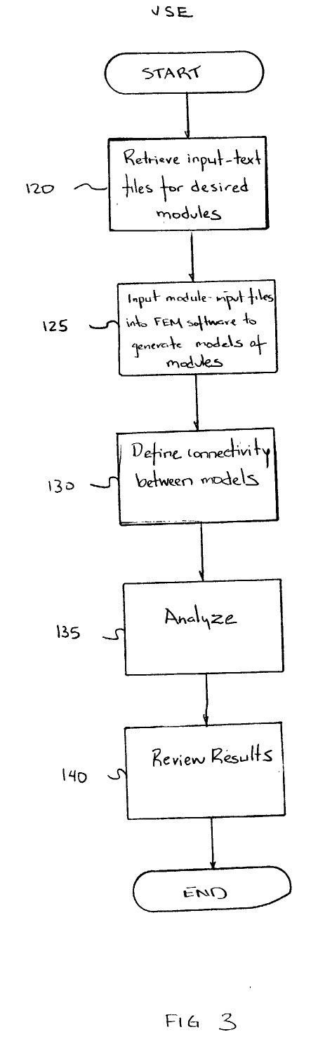

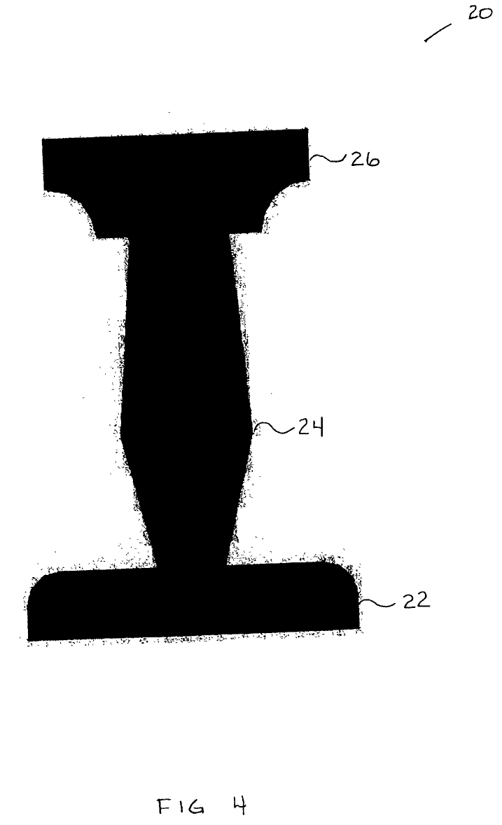

A description will now be made with reference to FIGS. 2 through 5 of an exemplary embodiment of the present invention. FIGS. 2 and 3 illustrate exemplary steps in the present invention. The steps are divided into two phases: Preparation and Use. Steps 100-115 of FIG. 2 comprise the Preparation phase. In the Preparation phase, a user begins by conceptually dividing the product or assembly to be modeled into separate segments (step 100). FIG. 4 illustrates an example of a product 20 to be modeled. The product 20 may be conceptually divided in many ways. The manner in which the product 20 is divided is a matter of individual choice and is influenced by factors such as the physical geometry of a product, the components involved in manufacturing a product, and the manner in which a product is physically integrated. For exemplary purposes, the product 20 has been segmented in FIG. 4 into a base 22, a center section 24, and a top 26.

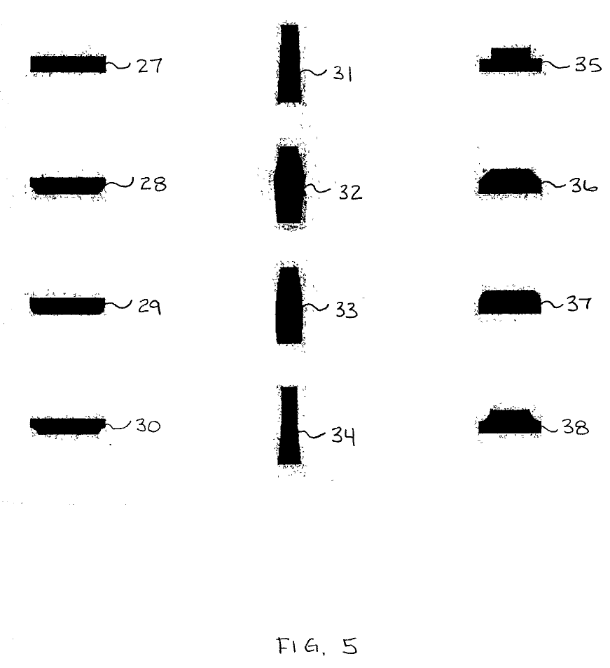

Once the product 20 has been conceptually divided into components, desired variations of each segment are identified (step 105). These variations may be based, for example, on physical and/or geometric modifications that are likely to be made to a segment during the design process. These multiple variations form the basis for multiple modules. FIG. 5 illustrates modules 27-38 corresponding to the segments 22, 24, and 26 of FIG. 4. The modules can be thought of as “off the shelf” components to be swapped in an out of a product model as desired. As will be discussed further below, by utilizing these modules, methods consistent with the present invention enable slight or even major geometric shape variations in segments during the modeling process. In FIG. 5, the base segment 22 has been geometrically varied to create four base-segment modules 27, 28, 29, 30. The center-section segment 24 has been geometrically varied to create four center-section-segment modules 31, 32, 33, 34. The top segment 26 has been geometrically varied to create four top-segment modules 35, 36, 37, 38.

Once the product has been conceptually divided into segments and modules, module-input-text files corresponding to the modules are created, along with support input-text files (step 110). For purposes of illustration, description will be made of input-text files corresponding to the third top-segment module, the second center-section-segment module, and the fourth base-segment module illustrated in FIG. 5. Description will also be made of support input-text files for assembling the modules (assembly.txt) and for defining common parameters in the modules (common.txt).

Table 1 illustrates a listing of computer program instructions for defining the third top-segment module (tpblck3.txt) in a syntax consistent with ANSYS™ FEM software. As will be understood by one of skill in the art, the computer program instructions listed in Table 1 include instructions for defining geometry, meshes, and interfaces in the third top-segment module. Lines 1 through 14 provide instructions to the FEM software for pre-modeling preparation, such as the definition of element types and material properties. Lines 15 through 26 define the parameters to be utilized in the module. These parameters may alternatively be provided in a separate, centralized “common.txt” data file. If the variable “ifile” in the common.txt data file is not set to one, the parameters will be understood to be specified in the module-input-text file. Lines 27 through 44 build the FEM model for the third-top-segment module. Lines 45 through 46 group the contact nodes together, “ntb_cc”, for subsequent contact element creation in the assembly phase. Lines 47 through 48 write all the selected entities, including the solid model and the FEM model, into a memory storage device in the data processing system, giving them the name “topblock”. Two files are created by line 48: “topblock” and “topblock.igs”.

TABLE 1

| LINE # | INSTRUCTION | |
|---|---|---|
| 1 | ! | |
| 2 | ! | Modular Parametric Input File for Top Block #3: |
| | | tpblck3.txt |
| 3 | ! | |
| 4 | /clear,start | |
| 5 | /prep7 | |
| 6 | ! | |
| 7 | ! | Define element type for top block #3 |
| 8 | ! | |
| 9 | et,1,42 | |
| 10 | ! | |
| 11 | ! | Define material properties for top block #3 |
| 12 | ! | |
| 13 | ex,1,16e6 | |
| 14 | nuxy,1,.35 | |
| 15 | ! | |
| 16 | ! | Define parameters for top block #3 |

| 17 | ! | |
|---|---|---|
| 18 | /input,common,txt | ! read parameters from the central data file |
| 19 | *if,ifile,ne,1,then | |

| | | |
|---|---|---|
| 20 | wt1=5 | ! width of top block |
| 21 | ht1=1 | ! height of top block |
| 22 | rt1=0.5 | ! radius of top block |
| 23 | tbloc=6.5 | ! vertical location of bottom of top block |
| 24 | ! | |
| 25 | esize,0.3 | ! length of element size = 0.3 |

| 26 | *endif | |
|---|---|---|
| 27 | ! | |
| 28 | ! | build top block |
| 29 | ! | |

| | | |
|---|---|---|
| 30 | local,11,,,tbloc | ! change local coordinate system to height |
| | | at hb1+hc1 |

| 31 | k,,−wt1/2,ht1 | |
|---|---|---|
| 32 | k,,wt1/2,ht1 | |
| 33 | k,,wt1/2,rt1 | |
| 34 | k,,wt1/2−rt1,rt1 | |
| 35 | k,,wt1/2−rt1 | |
| 36 | k,,−wt1/2+rt1 | |
| 37 | k,,−wt1/2+rt1,rt1 | |
| 38 | k,,−wt1/2,rt1 | |
| 39 | larc,3,5,4,rt1 | |
| 40 | larc,6,8,7,rt1 | |
| 41 | a,1,2,3,5,6,8 | ! generate area from keypoint 1,2,3,5,6,8 |
| 42 | type,1 | |
| 43 | mat,1 | |
| 44 | amesh,1 | |
| 45 | nsel,s,loc,y | |
| 46 | cm,ntb_cc,node | ! define nodes for contact elements |
| 47 | alls | |
| 48 | cdwrite,all,topblock | ! write solid model to an iges file |
| 49 | alls | |
| 50 | finish | |
| 51 | /eof | |

Table 2 illustrates a listing of computer program instructions for defining the second center-section-segment module (ctrclmn2.txt) in a syntax consistent with ANSYS™ FEM software. As will be understood by one of skill in the art, the computer program instructions listed in Table 2 include instructions for defining geometry, meshes, and interfaces in the second center-section-segment module. Lines 1 through 14 provide instructions to the FEM software for pre-modeling preparation, such as the definition of element types and material properties. Lines 15 through 28 define the parameters to be utilized in the module. These parameters may alternatively be provided in a separate, centralized “common.txt” data file. Lines 29 through 41 build the FEM model for the second center-section-segment module. Lines 42 through 46 group the contact nodes together, “ntb_cc”, for subsequent contact element creation in the assembly phase. Lines 47 through 48 write all the selected entities, including the solid model and the FEM model, into memory.

TABLE 2

| LINE # | INSTRUCTION | |
|---|---|---|
| 1 | ! | |
| 2 | ! | Modular Parametric Input File for Center Column #2: ctrclmn2.txt |
| 3 | ! | |
| 4 | /clear, start | |
| 5 | /prep7 | |
| 6 | ! | |
| 7 | ! | Define element type for center column #2 |
| 8 | ! | |
| 9 | et,1,42 | |
| 10 | ! | |
| 11 | ! | Define material properties for center column #2 |
| 12 | ! | |
| 13 | ex,1,25e6 | |
| 14 | nuxy,1,.3 | |
| 15 | ! | |
| 16 | ! | Define parameters for center column #2 |
| 17 | ! | |

| | | |
|---|---|---|
| 18 | /input,common,txt | ! read parameters from the central data file |

| 19 | *if,ifile,ne,1,then | |
|---|---|---|
| 20 | wc1=1 | ! top width of center column |
| 21 | wc2=2 | ! middle width of center column |
| 22 | wc3=1.5 | ! bottom width of center column |
| 23 | hc1=5 | ! height of center column |
| 24 | hc2=3 | ! height from bottom of center column to middle width |
| 25 | ccloc=1.5 | ! vertical location of center column |
| 26 | ! | |
| 27 | esize,0.3 | ! length of element size = 0.3 |
| 28 | *endif | |
| 29 | ! | |

| | | |
|---|---|---|
| 30 | local,11,,,ccloc | ! change local coordinate system to height at hbloc |
| 31 | k,,−wc1/2,hc1 | |
| 32 | k,,wc1/2,hc1 | |
| 33 | k,,−wc2/2,hc2 | |
| 34 | k,,wc2/2,hc2 | |
| 35 | k,,−wc3/2, | |
| 36 | k,,wc3/2, | |
| 37 | a,1,3,5,6,4,2 | |
| 38 | type,1 | |
| 39 | mat,1 | |
| 40 | amesh,1 | |
| 41 | nsel,s,loc,y | |
| 42 | cm,ncc_bb,node | ! define bottom nodes for column to base block |
| 43 | contact | |
| 44 | nsel,s,loc,y,hc1 | |
| 45 | cm,ncc_tb,node | ! define top nodes for column to top block contact |
| 46 | alls | |
| 47 | cdwrite,all,ctcolumn | ! write solid model to an iges file |
| 48 | finish | |
| 49 | /eof | |
| 50 | | |

Table 3 illustrates a listing of computer program instructions for defining the fourth base-segment module (bsblck4.txt) in a syntax consistent with ANSYS™ FEM software. As will be understood by one of skill in the art, the computer program instructions listed in Table 3 include instructions for defining geometry, meshes, and interfaces in the fourth base-segment module. Lines 1 through 14 provide instructions to the FEM software for pre-modeling preparation, such as the definition of element types and material properties. Lines 15 through 25 define the parameters to be utilized in the module. These parameters may alternatively be provided in a separate, centralized “common.txt” data file. Lines 26 through 45 build the FEM model for the fourth base-segment module. Lines 46 through 48 group the contact nodes together, “ntb_cc”, for subsequent contact element creation in the assembly phase. Lines 49 through 50 write all the selected entities, including the solid model and the FEM model, into memory.

TABLE 3

| LINE # | INSTRUCTION | |
|---|---|---|
| 1 | ! | |
| 2 | ! | Modular Parametric Input File for Base Block #4: |
| | | bsblck4.txt |
| 3 | ! | |
| 4 | /clear,start | |
| 5 | /prep7 | |
| 6 | ! | |
| 7 | ! | Define element type for base block #4 |
| 8 | ! | |
| 9 | et,1,42 | |
| 10 | ! | |
| 11 | ! | Define material properties for base block #4 |
| 12 | ! | |
| 13 | ex,1,30e6 | |
| 14 | nuxy,1,.3 | |
| 15 | ! | |
| 16 | ! | Define parameters for base block #4 |
| 17 | ! | |

| | | |
|---|---|---|
| 18 | /input,common,txt | ! read parameters from the central data file |
| 19 | *if,ifile,ne,1,then | |

| | | |
|---|---|---|
| 20 | wb1=4 | ! width of base block |
| 21 | hb1=1.5 | ! height of base block |
| 22 | rb1=0.75 | ! radius of base block |
| 23 | ! | |
| 24 | esize,0.3 | ! length of element size = 0.3 |
| 25 | *endif | |
| 26 | ! | |

| | | |
|---|---|---|
| 27 | csys | ! change to global coordinate system |

| 28 | k,,−wb1/2 | |
|---|---|---|
| 29 | k,,wb1/2 | |
| 30 | k,,wb1/2,hb1−rb1 | |
| 31 | k,,wb1/2,hb1 | |
| 32 | k,,wb1/2−rb1,hb1 | |
| 33 | k,,−wb1/2+rb1,hb1 | |
| 34 | k,,−wb1/2,hb1 | |
| 35 | k,,−wb1/2,hb1−rb1 | |
| 36 | larc,3,5,4,rb1 | |
| 37 | larc,6,8,7,rb1 | |
| 38 | a,1,2,3,5,6,8 | |
| 39 | ! | |
| 40 | ! | mesh area #1 |

| 41 | ! | |
|---|---|---|
| 42 | type,1 | |
| 43 | mat,1 | |
| 44 | amesh,1 | |
| 45 | | |
| 46 | nsel,s,loc,y,hb1 | |
| 47 | cm,nbb_cc,node | ! define bottom nodes for base |
| | | block to column |
| 48 | contact | |
| 49 | alls | |
| 50 | cdwrite,all,basblock | ! write solid model to an iges file |
| 51 | finish | |
| 52 | /eof | |

Table 4 illustrates a listing of computer program instructions for defining the an assembly file (assembly.txt) in a syntax consistent with ANSYS™ FEM ware. Lines 1 through 9 provide the FEM software with instructions for pre-assembly preparation. Line 10 reads the pre-stored files “basblock” and “baseblock.igs” into the FEM software. Line 11 reads the pre-stored files “ctcolumn” and “ctcolumn.igs” into the FEM software. Line 12 reads the pre-stored files “topblock” and “topblock.igs” into the FEM software. Lines 13 through 16 define the friction coefficient to be used by contact pairs. Lines 17 through 44 create an ANSYS™ macro file for creating contact elements. Lines 45 through 65 create the contact elements for two contact pairs: top block to center column and center column to base block. Lines 66 through 70 save the solid model and FEM model into the memory storage device for the subsequent analysis.

TABLE 4

| LINE # | INSTRUCTION |
|---|---|
| 1 | ! |
| 2 | ! Modular Parametric Input File for Assembly: assembly.txt |
| 3 | ! Assembly phase: generate contact elements between |
| | three components |
| 4 | ! |
| 5 | /clear, start |
| 6 | /prep7 |
| 7 | ! |
| 8 | ! read in all modular FEA models saved in iges format |
| 9 | ! |
| 10 | cdread,all,basblock |
| 11 | cdread,all,ctcolumn |
| 12 | cdread,all,topblock |
| 13 | ! |
| 14 | ! Define friction coefficient for contact elements |
| 15 | ! |
| 16 | mu,4,0.3 |
| 17 | ! |
| 18 | ! create an ANSYS macro file to generate contact pairs |
| 19 | ! |
| 20 | *create,contact,mac |
| 21 | !* |
| 22 | /COM, CONTACT PAIR CREATION MACRO FILE |
| 23 | !* |
| 24 | mat,arg1 |
| 25 | R,arg2,0,0,1,0.1,0,0, |
| 26 | RMORE,0,0,1000000,0,1,0, |
| 27 | RMORE,0, |
| 28 | real,arg2 |
| 29 | et,arg3,169 |
| 30 | et,arg3+1,171 |
| 31 | ! Generate the target surface |
| 32 | cmsel,s,nt |
| 33 | TYPE,arg3 |
| 34 | ESLN,S,0 |
| 35 | ESURF,ALL |
| 36 | ! Generate the contact surface |
| 37 | cmsel,s,nc |
| 38 | TYPE,arg3+1 |
| 39 | ESLN,S,0 |
| 40 | ESURF,ALL |
| 41 | esel,s,type,,arg3,arg3+1 |
| 42 | eplot |
| 43 | *end |
| 44 | |
| 45 | !* |
| 46 | /COM, CONTACT PAIR CREATION - top block to |
| | center column |
| 47 | !* |
| 48 | NSEL,S,,,ntb_cc |
| 49 | cm,nt,node |
| 50 | NSEL,S,,,ncc_tb |
| 51 | cm,nc,node |
| 52 | contact,4,1,4 |
| 53 | cm,etw_rg,elem |
| 54 | alls |
| 55 | |
| 56 | !* |
| 57 | /COM, CONTACT PAIR CREATION - bottom block to |
| | center column |
| 58 | !* |
| 59 | NSEL,S,,,nbb_cc |
| 60 | cm,nt,node |
| 61 | NSEL,S,,,ncc_bb |
| 62 | cm,nc,node |
| 63 | contact,4,2,6 |
| 64 | cm,etw_rg,elem |
| 65 | alls |
| 66 | |
| 67 | finish |
| 68 | save,pedestal,db |
| 69 | /exit,nosa |
| 70 | /eof |

Table 5 illustrates a listing of computer program instructions for defining the a common file (common.txt) in a syntax consistent with ANSYS™ FEM software. Line 7 defines a variable “ifile” equal to one so that the parameters for the modular-input-text files are specified by this data file. Lines 8 through 28 define the geometry of the three components. Line 29 defines the global element size for the three FEM modules. Lines 31 through 32 specify the relative location of each component.

TABLE 5

| LINE # | INSTRUCTION | |
|---|---|---|
| 1 | ! | |
| 2 | ! | Modular Parametric Input File for Central Data File: |
| | | common.txt |
| 3 | ! | |
| 4 | ! | This data file will be read in for all modular parametric |
| | | files and |
| 5 | ! | should be saved in the working directory |
| 6 | ! | |
| 7 | ifile=1 | |
| 8 | ! | |
| 9 | ! | Define parameters for top block #3 |
| 10 | ! | |

| | | |
|---|---|---|
| 11 | wt1=5 | ! width of top block |
| 12 | ht1=1 | ! height of top block |
| 13 | rt1=0.5 | ! radius of top block |
| 14 | ! | |

| | | |
|---|---|---|
| 15 | ! | Define parameters for center column #2 |
| 16 | ! | |

| | | |
|---|---|---|
| 17 | wc1=1 | ! top width of center column |
| 18 | wc2=2 | ! middle width of center column |
| 19 | wc3=1.5 | ! bottom width of center column |
| 20 | hc1=5 | ! height of center column |
| 21 | hc2=3 | ! height from bottom of center column to |
| | | middle width |
| 22 | ! | |

| | | |
|---|---|---|
| 23 | ! | Define parameters for base block #4 |
| 24 | ! | |

| | | |
|---|---|---|
| 25 | wb1=4 | ! width of base block |
| 26 | hb1=1.5 | ! height of base block |
| 27 | rb1=0.75 | ! radius of base block |
| 28 | ! | |
| 29 | esize,0.3 | ! length of element size = 0.3 |
| 30 | ! | |
| 31 | tbloc=6.5 | ! vertical location of bottom of the top block |
| 32 | ccloc=1.5 | ! vertical location of bottom of the center column |
| 33 | ! | |
| 34 | /eof | |

Once module-input-text files and support files have been created, they may be stored for subsequent use in, for example, secondary storage of a user's data processing system (step 115). This ends the Preparation phase. Next, steps 120 through 140 of FIG. 3 describe the Use phase of an exemplary embodiment of the present invention.

In the Use phase, a user begins by retrieving selected module-input-text files corresponding to a version of the product that the user wishes to model (step 120). The user then inputs the selected module-input-text files into the FEM software (step 125), creates the FEM models, and saves the models to memory. Next, the user defines the connectivity between the models (step 130). This may be done by with the assembly.txt file, which includes instructions for retrieving saved FEM models and for defining the connectivity between them. The user may also optionally use a common.txt file for defining parameters in the product model. Once the necessary files are input into the FEM software, an analysis may be run (step 135) and the results reviewed (step 140).

A significant advantage of methods consistent with the present invention is that, once module input-text files have been created, a model of a product can easily be varied, without requiring a completely new input-text file for each such variation. With methods consistent with the present invention, a user may simply select a new set of module-input text files and quickly re-model and re-analyze the product. If, for example, a user had created a model for the product 20 (illustrated in FIG. 4) based on modules 29, 32, and 38 (illustrated in FIG. 5) and the user then wanted to model the product 20 with the fourth top-block module 30, the user could redefine parameters to be changed in either the common.txt data file or directly in the modular files, then input the modular files corresponding to the new model (including new top-block module 30), and then input the assembly file to create a new model reflecting the newly selected module 30. In this way, the user could quickly and easily compare the characteristics of a number of variations of the product, without having to write long, complex input-text file for each such variation.

The present invention has been described with reference to the accompanying drawings that illustrate preferred embodiments of the invention. The invention may, however, be embodied in many different forms and should not be construed as limited to the embodiments set forth herein. Rather, these embodiments are provided so that this disclosure will be thorough and complete, and will fully convey the scope of the invention to those skilled in the art. Thus, the scope of the invention should be determined based upon the appended claims and their legal equivalents, rather than the specific embodiments described above.

What is claimed is:

1. A method of modeling a product with finite-element-modeling (FEM) software, comprising the steps of:
(a) conceptually dividing said product into a plurality of segments;
(b) determining desired variations to said segments to conceptually define a plurality of modules for each of said segments;
(c) creating module-input-text files corresponding to each of said plurality of modules;
(d) storing said module-input-text files in a memory of a data processing system for subsequent use with said FEM software;
(e) generating a model of a selected product comprising a selected module for each of said segments of said product by
(i) retrieving said module-input-text files corresponding to each of said selected modules;
(ii) inputting said module-input-text files into said FEM software; and
(iii) defining interactivity and connectivity between said selected FEM modules and to form an assembled model of said product; and
(f) performing an analysis of said model of said product using said FEM software.

2. The method of claim 1 further including the step of debugging and testing said module-input-text files corresponding to each of said plurality of modules.

3. The method of claim 1 further including the step of inputting a separate, centralized common file containing instructions for defining parameters in said modular-input-text files.

4. The method of claim 1 wherein said step of defining interactivity and connectivity between said selected modules comprises inputting an assembly-input-text file into said FEM containing software defining interactivity and connectivity between said selected modules.

5. The method of claim 1 wherein said step of determining desired variations to said segments includes determining desired geometric-shape variations to conceptually define a plurality of modules for each of said segments.

6. The method of claim 1 wherein said FEM software is software selected from the group consisting of ANSYS™, ADINA™, and ABAQUS™.

7. A method of modeling a product using finite-element-modeling (FEM) software in a data processing system, comprising the steps of:
(a) retrieving from said data processing system pre-prepared module-input-text files for each of a plurality of selected modules corresponding to said product to be modeled;
(b) inputting said module-input-text files into said FEM software to generate models of said selected modules of said product;
(c) storing said models of said selected modules in said data processing system;
(d) inputting an assembly-input-text file into said FEM software, which retrieves said stored modules, defines connectivity and interactivity between said modules, and generates an assembled model of said product; and
(e) performing an analysis on said model by applying loads to said model using said FEM software.

8. The method of claim 7 further including the step of testing and debugging said module-input-text files.

9. The method of claim 7 further including the step of retrieving a pre-prepared common file containing instructions for defining parameters in said modular-input-text files corresponding to said product to be modeled.

10. The method of claim 7 wherein said FEM software is software selected from the group consisting of ANSYS™, ADINA™, and ABAQUS™.

11. The method of claim 7 further comprising the step of storing said model of said product as a sub-assembly for subsequent use in a multi-assembly model.

12. A method of modeling a product using finite-element-modeling (FEM) software in a data processing system, comprising the steps of:
(a) retrieving from said data processing system pre-prepared module-input-text files for modules corresponding to said product to be modeled;
(b) modifying parameters in said input-text files to effect desired changes in said product to be modeled;
(c) inputting said module-input-text files into said FEM software to generate models of said modules;
(d) storing said models in said data processing system;
(e) retrieving from said data processing system a pre-prepared assembly-input file, said assembly-input file including instructions for defining multiple-domain connectivity between said modules and for retrieving said stored models;
(f) inputting said assembly-input file into said FEM software, thereby retrieving said stored models and generating an assembled model of said product; and
(e) performing an analysis on said assembled model by applying loads to using said FEM software.

13. The method of claim 12 further including the step of debugging and testing said module-input-text files corresponding to each of said plurality of modules.

14. The method of claim 12 further including the step of inputting a separate, centralized common file containing instructions for defining parameters in said modular-input-text files.

15. The method of claim 12 wherein said FEM software is software selected from the group consisting of ANSYS™, ADINAT™, and ABAQUS™.

16. A method of modeling a product with finite-element-modeling (FEM) software in a data processing system using pre-existing non-parametric FEM models, comprising the steps of:
(a) retrieving said pre-existing FEM models from said data processing system;
(b) modifying said pre-existing non-parametric FEM models to delete instructions not utilized by a modular-input-text file; and
(c) storing said modified FEM models as modular-input-text files for subsequent use in a subsequent modular modeling session.
